(19) United States
(12) Patent Application Publication
(10) Pub. No.: US 2011/0138538 A1
(43) Pub. Date: Jun. 16, 2011

(54) WEIGHT EFFICIENT FLUIDIZED BED

(76) Inventor: Charles A. Howell, Batesville, IN (US)

(21) Appl. No.: 12/634,934

(22) Filed: Dec. 10, 2009

(51) Int. Cl. A61G 7/057; A47C 20/02; A47C 16/00

(52) U.S. Cl. 5/689; 5/652.1; 5/655.3

(57) ABSTRACT

A person-support apparatus comprises a container and a gas permeable support. The container is supported on a frame. The container includes a base and sides extending from the base to define an opening opposite the base. The gas permeable support is positioned within the container and cooperates with the base to define a chamber. The gas permeable support includes a first portion and a second portion. The first portion is generally parallel the base. The second portion is coupled to the first portion and forms an obtuse angle therewith. The gas permeability of the second portion varies as a function of the distance between the second portion and the opening.

### BACKGROUND OF THE DISCLOSURE

This disclosure relates generally to fluidized person-support apparatuses. More particularly, but not exclusively, one illustrative embodiment relates to a weight efficient fluidized person-support apparatus.

Some people can be required to remain on person-support apparatuses for extended periods of time. In some instances, pressure on tissues that interface with the person-support apparatus can be comparably higher at or near protuberances of the surface of the body, such as, for example, the heels, the buttocks, and the head. The high interface pressures can increase the probability that pressure sores or decubitus ulcers will develop over time. Fluidized person-support apparatuses can be used to help reduce the interface pressures by fluidizing granular medium to buoyantly suspend a person supported thereon, thereby increasing the surface area being supported and helping distribute the interface pressure points substantially uniformly there along. The volume of the fluidizable medium in the tank is generally greater the volume needed to suspend the person, which can cause the fluidized person-support apparatus to weigh more than non-fluidizable person-support apparatuses. While various fluidized person-support apparatuses have been developed, there is still room for improvement. Thus a need persists for further contributions in this area of technology.

### SUMMARY OF THE DISCLOSURE

The present disclosure includes one or more of the features recited in the appended claims and/or the following features which, alone or in any combination, may comprise patentable subject matter.

One illustrative embodiment of the present disclosure can include a fluidized person-support apparatus with a tank and a gas permeable support positioned in the tank that has a porosity that varies as a function of the distance between the gas permeable support and the opening into the tank.

Additional features alone or in combination with any other feature(s), including those listed above and those listed in the claims and those described in detail below, can comprise patentable subject matter. Others will become apparent to those skilled in the art upon consideration of the following detailed description of illustrative embodiments exemplifying the best mode of carrying out the invention as presently perceived.

### BRIEF DESCRIPTION OF THE DRAWINGS

Referring now to the illustrative examples in the drawings, wherein like numerals represent the same or similar elements throughout:

FIG. 1 is a perspective view of a fluidized person-support apparatus according to an illustrative embodiment;

FIG. 2 is a perspective view of the fluidized person-support apparatus according to another illustrative embodiment;

FIG. 3 is a cross-sectional side view of the person-support apparatus along lines X1-X1 of FIG. 2 showing a profile of the diffuser;

FIG. 4 is a cross-sectional frontview of the person-support apparatus along lines Y1-Y1 of FIG. 2 showing an inclined second diffuser according to one illustrative embodiment;

FIG. 5 is a cross-sectional front view of the person-support apparatus along lines Y1-Y1 of FIG. 2 showing a curved second diffuser according to one illustrative embodiment ;

FIG. 6 is a cross-sectional front view of the person-support apparatus along lines Y1-Y1 of FIG. 2 showing an inflatable diffuser according to one illustrative embodiment;

FIG. 7 is a cross-sectional front view of the person-support apparatus along lines Y1-Y1 of FIG. 2 showing an inflatable diffuser including a first inflatable portion and a second inflatable portion according to one illustrative embodiment;

FIG. 8 is a cross-sectional front view of the person-support apparatus along lines Y1-Y1 of FIG. 2 showing a non-fluid permeable spacer according to one illustrative embodiment; and

FIG. 9 is a cross-sectional front view of the person-support apparatus along lines Y1-Y1 of FIG. 2 showing a fluid permeable spacer according to one illustrative embodiment.

### DETAILED DESCRIPTION OF THE DRAWINGS

While the present disclosure can take many different forms, for the purpose of promoting an understanding of the principles of the disclosure, reference will now be made to the embodiments illustrated in the drawings, and specific language will be used to describe the same. No limitation of the scope of the disclosure is thereby intended. Various alterations, further modifications of the described embodiments, and any further applications of the principles of the disclosure, as described herein, are contemplated.

One illustrative embodiment of the present disclosure can include a fluidized person-support apparatus with a tank and a gas permeable support positioned in the tank that has a porosity that varies as a function of the distance between the gas permeable support and the opening into the tank.

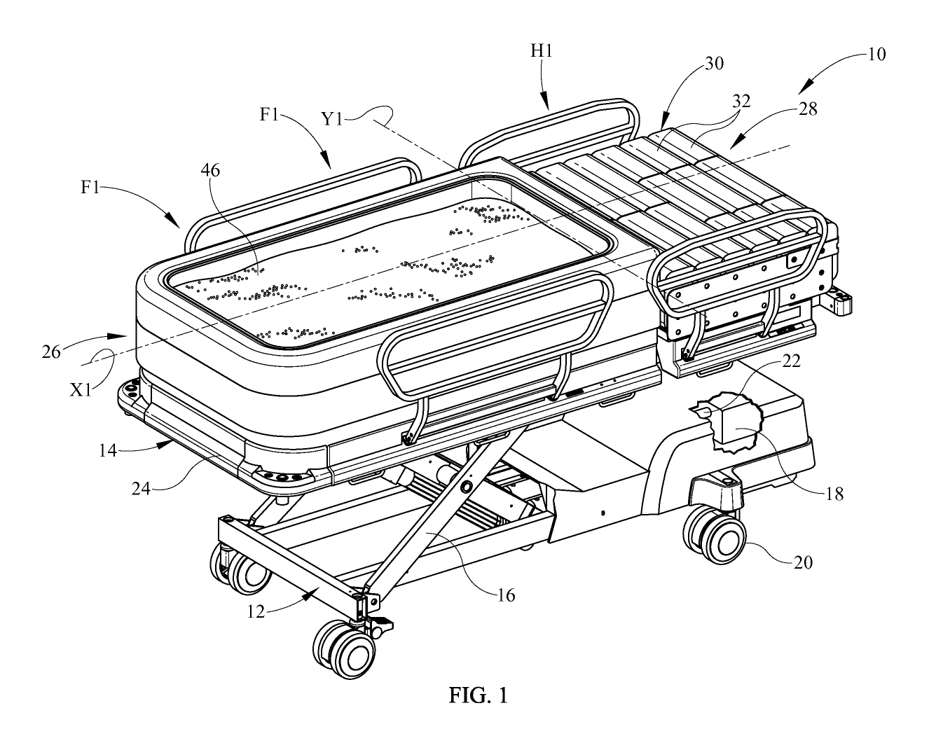

A person-support apparatus 10 according to one illustrative embodiment of the current disclosure is shown in FIGS. 1-9. The person-support apparatus 10 can be a fluidized hospital bed and can include a head section H1, where the head of a person (not shown) is positioned, and a foot section F1, where the feet of a person (not shown) are positioned. The person-support apparatus 10 can include a lower frame 12, an upper frame 14, a plurality of supports 16 supporting the upper frame 14 on the lower frame 12, and a gas supply unit 18. The lower frame 12 can be supported on casters 20 and can be coupled with the supports 16 to support the supports 16 and the upper frame 14.

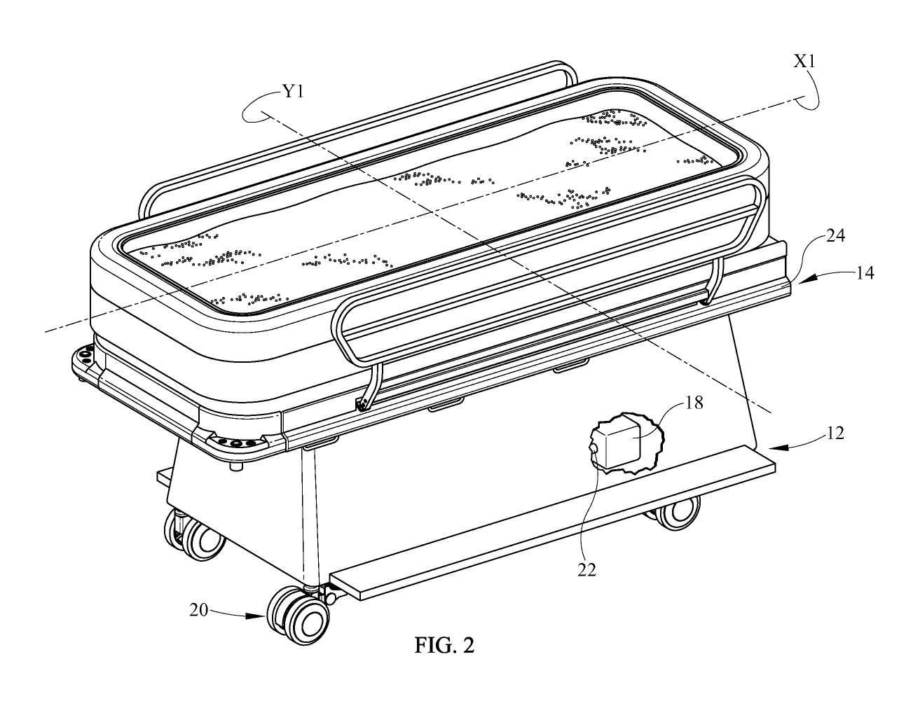

In one illustrative embodiment, the supports 16 can be coupled with the lower frame 12 and the upper frame 14 and can movably support the upper frame 14 above the lower frame 12 as shown in FIG. 1. The supports 16 can be lift mechanisms 16 with a lift driver (not shown) that can cause the lift mechanisms 16 to expand and/or contract to raise and/or lower the upper frame 14 with respect to the lower frame 12. In another illustrative embodiment, the supports 16 can fixedly support the upper frame 14 above the lower frame 12 as shown in FIG. 2.

The gas supply 18 can be integrated into the lower frame 12 and can be configured to supply the gas to the upper frame 14 as shown in FIGS. 1 & 2. It should be appreciated that the gas supply 18 can be removably coupled with or integrated into the upper frame 14 and/or the supports 16. It should also be appreciated that the gas can be remotely supplied, such as, by a head wall unit (not shown). In one illustrative embodiment, the gas supply 18 can be an air blower assembly 18. It should be appreciated that the gas supply 18 can vary the rate at which gas is supplied, as well as the temperature of the gas being supplied. The gas supply unit 18 can be connected to the upper frame 14 through at least one hose 22.

The upper frame 14 can define a longitudinal axis X1 that can extend at least the length of the person-support apparatus 10 through the head end H1 and the foot end F1 along the lateral center of the upper frame 14, and a lateral axis Y1 that can be perpendicular to the longitudinal axis X1 and can extend at least the width of the person-support apparatus 10 through the longitudinal center of the upper frame 14 as shown in FIGS. 1 & 2. It should be appreciated that the head end H1 can be movably coupled to the foot end F1 such that the head end H1 can move with respect to the foot end F1.

In one illustrative embodiment, the upper frame 14 can include an upper frame weldment 24 that can support a tank assembly 26 or container 26 and a head end support assembly 28 as shown in FIG. 1. It should be appreciated that the head end support assembly 28 can articulate with the head end H1 of the upper frame 14 respect to the tank assembly 26. It should also be appreciated that the head end support assembly 28 can be a person-support surface 30 or mattress 30 composed of foam (not shown) and/or having support assembly gas bladders 32. In another illustrative embodiment, the upper frame 14 can include an upper frame weldment 24 that supports a tank assembly 26 as shown in FIG. 2. The head end support assembly 28 of the upper frame 14 can be configured to support a portion of a person's head and/or torso while the tank assembly 26 can be configured to support the pelvic region and lower extremities of a person.

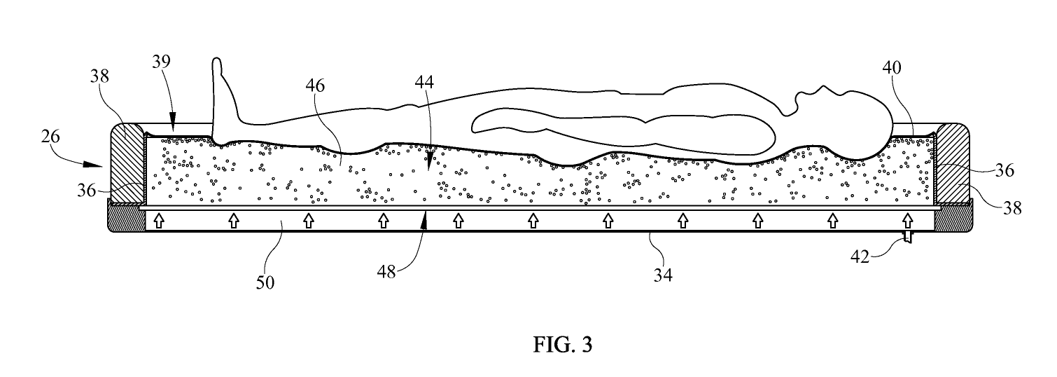

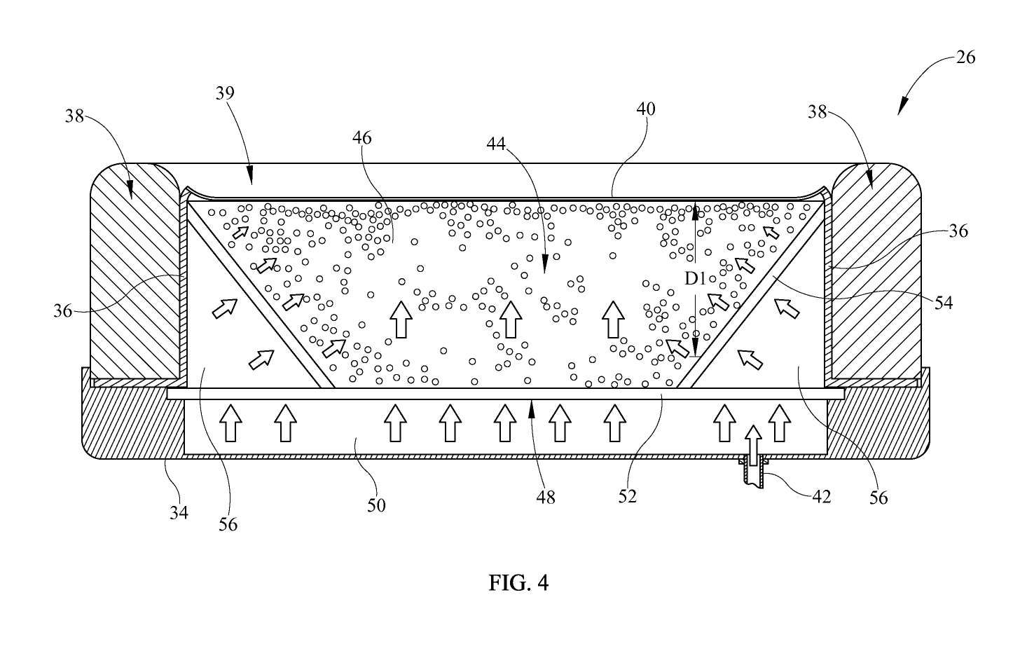

The tank assembly 26 can include a tank base 34, a tank liner 36, a tank bladder 38, and a filter cover 40 or gas permeable cover 40 as shown in FIGS. 3-4 & 6-9. In one illustrative embodiment, the tank base 34 and the tank liner 36 can be made of a low or substantially no air-loss material, such as, for example, a polyurethane-backed nylon fabric material, and the tank bladder 38 can be composed of a substantially no air loss polymeric material and filled with a gas, such as, air. The tank base 34 can be coupled to the upper frame weldment 24 by tank fasteners (not shown) and can include an inlet 42 that can couple with the hose 22. The tank liner 36 and the tank bladder 38 can be coupled together to form the sides of the tank assembly 26. The tank base 34 can be coupled with the tank liner 36 and the tank bladder 38 to define an opening 39 opposite the tank base 34.

The filter cover 40 can be positioned over the opening 39 and can be couple to the tank liner 36 with a cover fastener (not shown) as shown in FIGS. 3-4 & 6-9. It should be appreciated that the cover fasteners can be zippers, buttons, snaps, turn-buttons, hook and loop fasteners, or other fasteners. The tank base 34, the tank liner 36, the tank bladder 38, and the filter cover 40 can cooperate to define a chamber 44 therebetween.

The chamber 44 can contain fluidizable medium 46 and a diffuser 48 or gas permeable support 48 therein. The volume between the diffuser 48 and the filter cover 40 can be filled with the fluidizable medium 46 as shown in FIGS. 3-4 & 6-9. In one illustrative embodiment, the fluidizable medium 46 can be spherical silica beads of the type commonly employed in air fluidized bead person-support systems. It should also be appreciated that the fluidizable medium 46 can range in size from about 50 to about 150 microns in diameter, which can depend on the rate at which gas is supplied through the diffuser 48 and/or the depth and/or volume of the fluidizable medium 46. Similarly, the rate at which gas is supplied through the diffuser 48 can vary as a function of the size of the fluidizable medium 46 and the depth of the fluidizable medium 46, i.e., the distance between the diffuser 48 and the opening 39.

The diffuser 48 can be permeable to the gas supplied by the gas supply 18, but not permeable to the fluidizable medium 46. The diffuser 48 can be positioned proximate the tank base 34 and can cooperate with tank base 34 to define a plenum 50 as shown in FIGS. 3-4 & 6-9. The plenum 50 can receive gas from the gas supply 18 through the inlet 42 and can communicate the gas substantially uniformly through the diffuser 48. The gas in the plenum 50 can be pressurized depending on the flow rate from the gas supply 18 and the porosity of the first diffuser 48.

The profile shape and the design of the diffuser 48 can depend on a variety of factors, such as, for example, the relative porosity of the diffuser 48, the air pressure within plenum 50, the quantity of the fluidizable medium 46, and the patient weight. In one illustrative embodiment, the diffuser 48 can be configured to mimic the shape of the person's body. For example, the profile of the diffuser 48 can be lowered to accommodate a larger volume of fluidizable medium 46 below the person's thoracic and abdominal region as compared to the person's leg region.

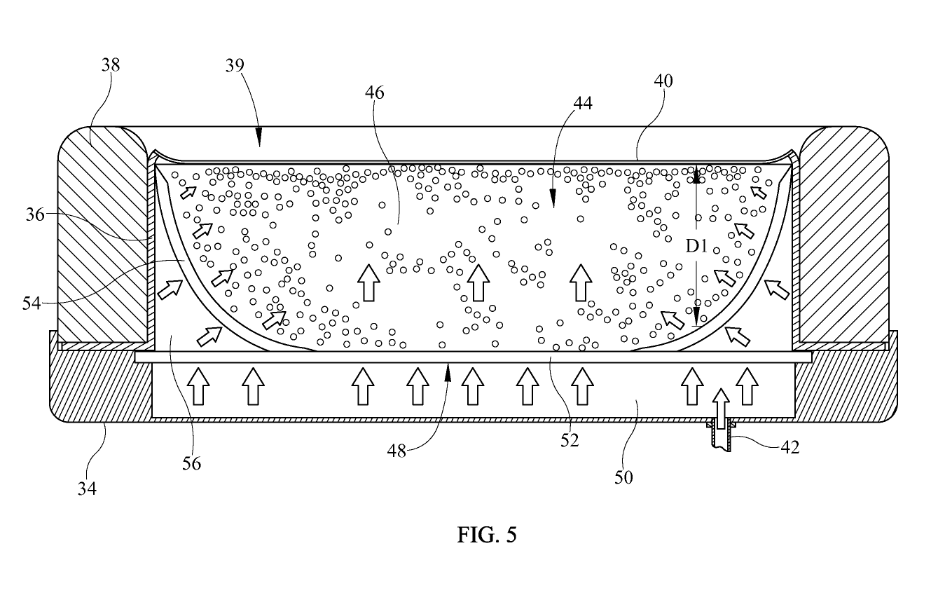

The diffuser 48 can include multiple portions. In one illustrative embodiment, the diffuser 48 can include a first diffuser portion 52 and a second diffuser portion 54 as shown in FIGS. 4 and 5. It should be appreciated that the first diffuser portion 52 and the second diffuser portion 54 can be separate diffusers 48 that can be coupled together. The first portion 52 can be positioned proximate the tank base 34 and can cooperate with tank base 34 to define the plenum 50. It should be appreciated that the first portion 52 and the second portion 54 can cooperate with the tank liner 36 and the tank base 34 to define the plenum 50.

The second portion 54 can be coupled to the tank liner 36 and the first portion 54 so that the second portion 54 is at an angle with respect to at least one of the tank liner 36 and the first portion 52. It should be appreciated that the second portion 54 can be coupled to the tank bladders 38 instead of or in addition to the tank liner 36. In one illustrative embodiment, the first portion 52 and the second portion can be substantially planar as shown in FIG. 4. In another illustrative embodiment, the first portion 52 can be substantially planar and the second portion can be curved as shown in FIG. 5. The second portion 54 can cooperate with the first portion 52 and the tank liner 36 to define a second plenum 56. The second plenum 56 can be configured to receive fluid through an opening (not shown) in the first portion 52 from the plenum 50. It should be appreciated that the second plenum 56 can be configured to receive fluid from the fluid supply 18 through a second inlet (not shown).

The second portion 54 can have a fluid porosity that varies as a function of the depth D1 of the fluidizable medium 46, i.e., the distance between the opening 39 and the second portion 54. It should be appreciated that the thickness of the second portion 54 can also be varied as a function of the depth of the fluidizable medium 46. For example, the fluid porosity of the second portion 54 can increase with an increase in depth of the fluidizable medium 46, i.e., the porosity of the second portion 54 is reduced the closer the second portion is to the opening 39, and increased the farther the second portion 54 is away from the opening 39. The reason for this is that less air is required to fluidize the fluidizable medium 46 as the depth of the fluidizable medium 46 is reduced.

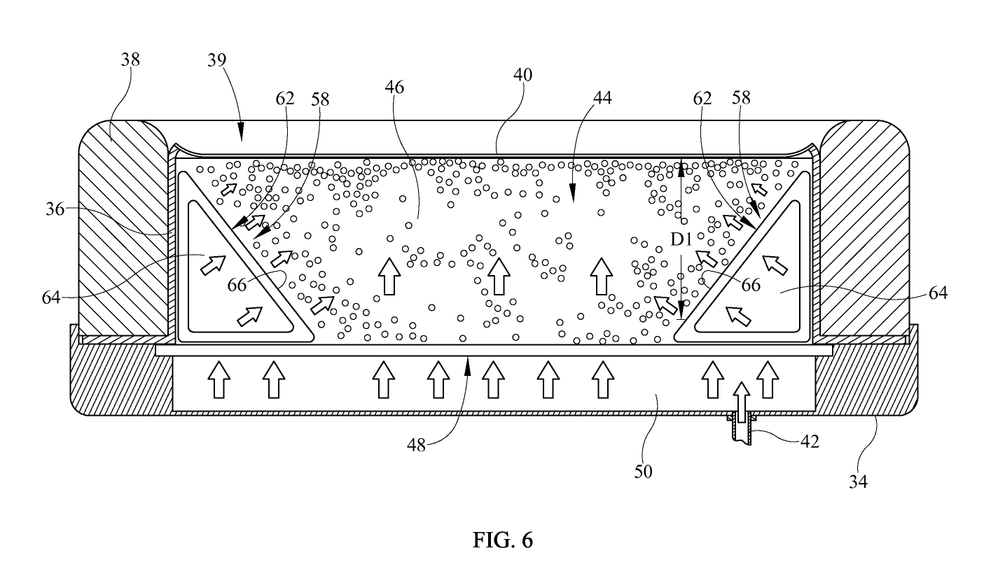

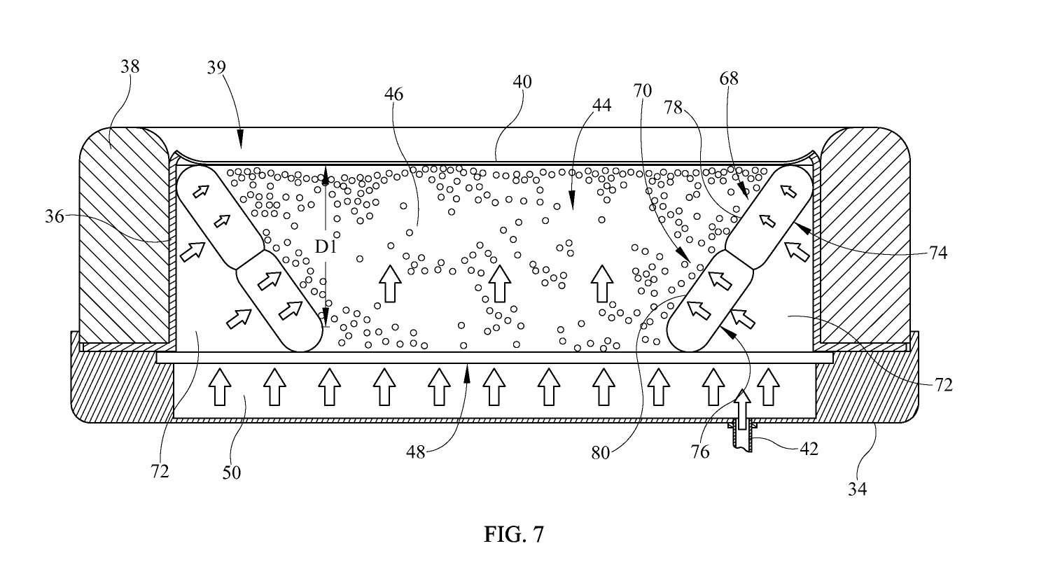

In another illustrative embodiment, the person-support apparatus 10 can include an inflatable diffuser 58 as shown in FIGS. 6 and 7. The inflatable diffuser 58 can be positioned adjacent the tank liner 36 and the diffuser 48 and coupled thereto. The inflatable diffuser 58 can be shaped to mimic the profile of an occupant's body. In one illustrative embodiment, the inflatable diffuser 58 can be a wedge shaped structure 58. The inflatable diffuser can include a housing 62 with an inner chamber 64 and a fluid permeable surface 66. The inner chamber 64 can receive fluid from the fluid supply 18 through an inlet (not shown). The fluid permeable surface 66 can contact the fluidizable medium 46 and can have a fluid porosity that varies as a function of the distance between the fluid permeable surface 66 and the opening 39.

In another illustrative embodiment, the inflatable diffuser 58 can include a first inflatable portion 68 and a second inflatable portion 70 as shown in FIG. 7. The first inflatable portion 68 and the second inflatable portion 70 can be coupled together and coupled to the tank liner 36 and diffuser 48. The first inflatable portion 70, the second inflatable portion 68, the tank liner 36, and the diffuser can cooperate together to form a support chamber 72. The support chamber 72 can be filled with fluid from the fluid supply 18 to support the first inflatable portion 68 and the second inflatable portion 70. The first inflatable portion 68 and the second inflatable portion 70 can include a first inflatable housing 74 and a second inflatable portion housing 76, a first fluid permeable surface 78 and a second fluid permeable surface 80, and a first inner chamber 82 and a second inner chamber 84, respectively. The first fluid permeable surface 78 can be configured to have a different fluid permeability than the second fluid permeable surface 80. In one illustrative embodiment, the first fluid permeable surface 78 can be less porous than the second fluid permeable surface 80. It should be appreciated that the first fluid permeable surface 78 and the second fluid permeable surface 80 can have a fluid porosity that varies as a function of the distance between the opening 39 and the first fluid permeable surface 78 and the second fluid permeable surface 80.

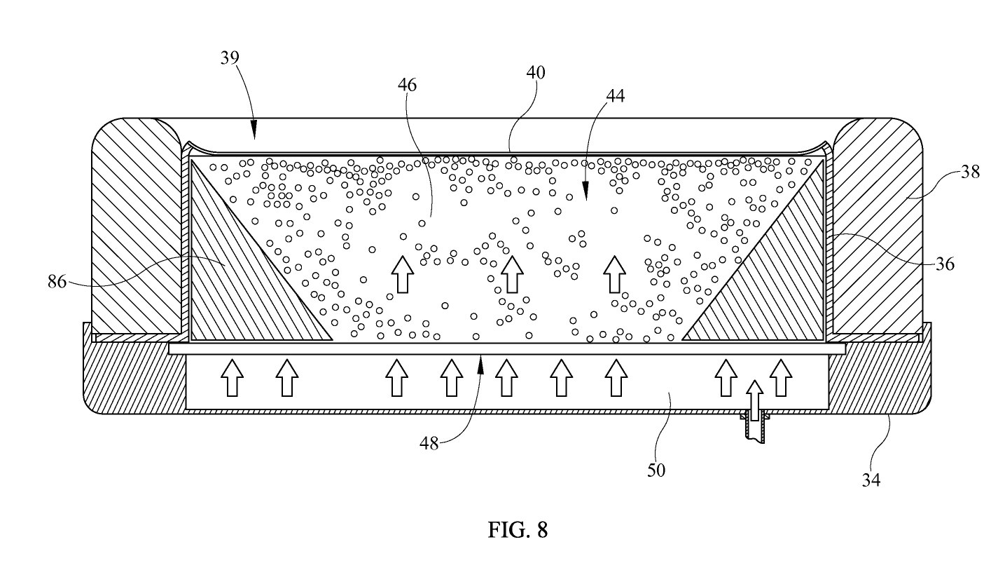

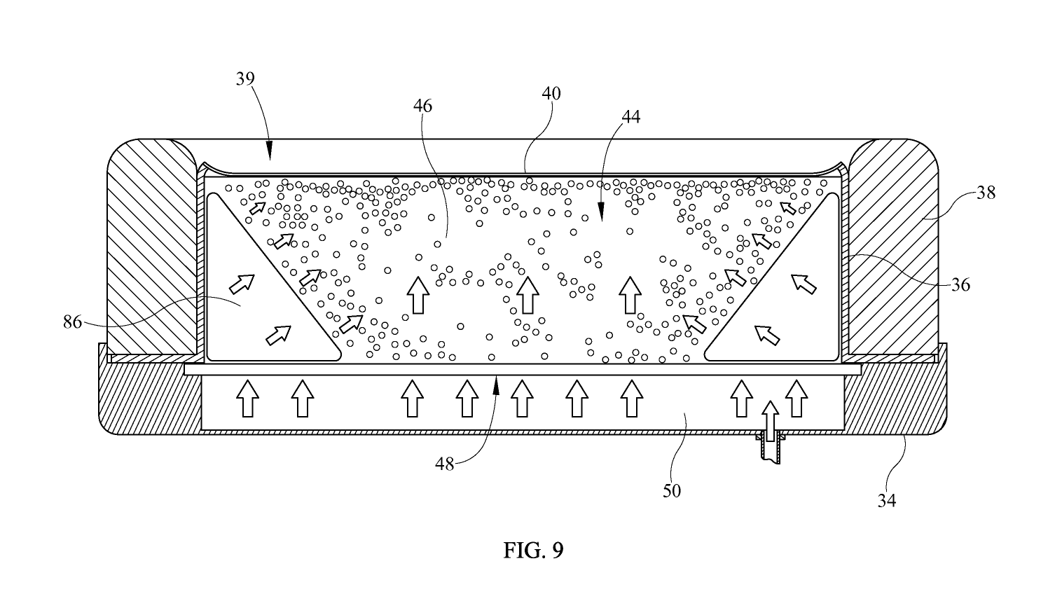

In another illustrative embodiment, the person-support apparatus 10 can include a volume occupier 86 as shown in FIGS. 8 and 9. The volume occupier 86 can be coupled to the tank liner 36 and diffuser 48. In one illustrative embodiment, the volume occupier 86 can be fluid impermeable as shown in FIG. 8. It should be appreciated that the fluid impermeable volume occupier 86 can be composed of a polymeric material, such as, for example, closed cell foam. In another illustrative embodiment, the volume occupier 86 can be composed open-cell foam, with a filter cover (not shown) coupled thereto between the volume occupier 86 and the fluidizable medium 46 as shown in FIG. 9. It should be appreciated that the polymeric material and/or filter cover can have a fluid permeability that varies as a function of the distance between the volume occupier 86 and the opening 39.

Many other embodiments of the present disclosure are also envisioned. For example, a person-support apparatus comprises a container and a gas permeable support. The container is supported on a frame. The container includes a base and sides extending from the base to define an opening opposite the base. The gas permeable support is positioned within the container and cooperates with the base to define a chamber. The gas permeable support includes a first portion and a second portion. The first portion is generally parallel the base. The second portion is coupled to the first portion and forms an obtuse angle therewith. The gas permeability of the second portion varies as a function of the distance between the second portion and the opening.

In another example, a person-support apparatus comprises a container, a gas permeable support, and a gas permeable cushion. The container is supported on a frame. The container includes a base and sides extending from the base to define an opening opposite the base. The gas permeable support is positioned within the container and cooperates with the base to define a chamber. The gas permeable cushion is adjacent the gas permeable support. The gas permeability of the gas permeable cushion varies as a function of the distance between the gas permeable support and the opening.

In yet another example, a person-support apparatus comprises a container, a gas permeable support, a fluidizable medium, and a gas impermeable cushion. The container is supported on a frame. The container includes a base and sides extending from the base to define an opening opposite the base. The gas permeable support is positioned within the container and cooperates with the base to define a chamber. The fluidizable medium is supported on the gas permeable support. The gas impermeable cushion is positioned within the container and is configured to inhibit fluidization of a portion of the fluidizable medium positioned between about the gas impermeable cushion and about the opening.

In yet another example, a person-support apparatus comprises a container, a gas permeable support, and an inflatable gas impermeable support. The container is supported on a frame. The container includes a base and sides extending from the base to define an opening opposite the base. The gas permeable support is positioned within the container and cooperates with the base to define a chamber. The inflatable gas permeable support is adjacent the gas permeable support. The gas permeability of the inflatable gas permeable support varies as a function of the distance between the gas permeable support and the opening.

In still another example, a person-support apparatus comprises a container and a curved gas permeable support. The container is supported on a frame. The container includes a base and sides extending from the base to define an opening opposite the base. The curved gas permeable support is positioned within the container and cooperates with the base to define a chamber. The gas permeability of the gas permeable support varies along the gas permeable support as a function of the distance between the gas permeable support and the opening.

Any theory, mechanism of operation, proof, or finding stated herein is meant to further enhance understanding of principles of the present disclosure and is not intended to make the present disclosure in any way dependent upon such theory, mechanism of operation, illustrative embodiment, proof, or finding. It should be understood that while the use of the word preferable, preferably or preferred in the description above indicates that the feature so described can be more desirable, it nonetheless can not be necessary and embodiments lacking the same can be contemplated as within the scope of the disclosure, that scope being defined by the claims that follow.

In reading the claims it is intended that when words such as “a,” “an,” “at least one,” “at least a portion” are used there is no intention to limit the claim to only one item unless specifically stated to the contrary in the claim. When the language “at least a portion” and/or “a portion” is used the item can include a portion and/or the entire item unless specifically stated to the contrary.

It should be understood that only selected embodiments have been shown and described and that all possible alternatives, modifications, aspects, combinations, principles, variations, and equivalents that come within the spirit of the disclosure as defined herein or by any of the following claims are desired to be protected. While embodiments of the disclosure have been illustrated and described in detail in the drawings and foregoing description, the same are to be considered as illustrative and not intended to be exhaustive or to limit the disclosure to the precise forms disclosed. Additional alternatives, modifications and variations can be apparent to those skilled in the art. Also, while multiple inventive aspects and principles can have been presented, they need not be utilized in combination, and various combinations of inventive aspects and principles are possible in light of the various embodiments provided above.

What is claimed is:

1. A person-support apparatus, comprising:
a container supported on a frame, the container including a base and sides extending from the base to define an opening opposite the base; and
a gas permeable support positioned within the container and cooperating with the base to define a chamber, wherein the gas permeable support includes a first portion and a second portion, the first portion being generally parallel the base, the second portion being coupled to the first portion and forming an obtuse angle therewith, the gas permeability of the second portion varying as a function of the distance between the second portion and the opening.

2. The person-support apparatus of claim 1, wherein the first portion cooperates with the base to define the chamber and the second portion cooperates with the first portion and the sides to define a second chamber.

3. The person-support apparatus of claim 1, wherein the gas permeability of the second portion decreases as the distance between the opening and the second portion decreases.

4. The person-support apparatus of claim 1, wherein the second portion is linear.

5. The person-support apparatus of claim 1, wherein the second portion is curved.

6. The person-support apparatus of claim 1, wherein the gas permeable support is shaped to mimic a profile of an occupant's body.

7. A person-support apparatus, comprising:
a container supported on a frame, the container including a base and sides extending from the base to define an opening opposite the base;
a gas permeable support positioned within the container and cooperating with the base to define a chamber; and
a gas permeable cushion adjacent the gas permeable support, wherein the gas permeability of the gas permeable cushion varies as a function of the distance between the gas permeable support and the opening.

8. The person-support apparatus of claim 7, wherein the gas permeable cushion includes a base and a gas permeable sheet coupled to a surface of the base, the gas permeability of the gas permeable sheet varies as a function of the distance between the gas permeable sheet and the opening.

9. The person-support apparatus of claim 8, wherein the gas permeable sheet contacts a fluidizable medium and is configured to prevent the fluidizable medium from passing therethrough.

10. The person-support apparatus of claim 8, wherein the base is composed of foam.

11. The person-support apparatus of claim 7, wherein the gas permeable cushion is configured to prevent an occupant from bottoming out against the gas permeable support.

12. A person-support apparatus, comprising:
a container supported on a frame, the container including a base and sides extending from the base to define an opening opposite the base;
a gas permeable support positioned within the container and cooperating with the base to define a chamber;
a fluidizable medium supported on the gas permeable support; and
a gas impermeable cushion positioned within the container and configured to inhibit fluidization of a portion of the fluidizable medium positioned between about the gas impermeable cushion and about the opening.

13. The person-support apparatus of claim 12, wherein the gas impermeable cushion is configured to prevent a portion of the fluidizable medium positioned between about the gas impermeable cushion and about the opening from fluidizing and allow a portion of the fluidizable medium positioned between about the gas impermeable cushion and about the opening to partially fluidize.

14. The person-support apparatus of claim 12, wherein the gas impermeable cushion is configured to prevent an occupant from bottoming out against the gas permeable support.

15. A person-support apparatus, comprising:
a container supported on a frame, the container including a base and sides extending from the base to define an opening opposite the base;
a gas permeable support positioned within the container and cooperating with the base to define a chamber; and
an inflatable gas permeable support adjacent the gas permeable support, wherein the gas permeability of the inflatable gas permeable support varies as a function of the distance between the gas permeable support and the opening.

16. The person-support apparatus of claim 15, wherein the inflatable gas permeable support is a fluid bladder.

17. The person-support apparatus of claim 15, wherein the inflatable gas permeable support is configured to prevent an occupant from bottoming out against the gas permeable support.

18. A person-support apparatus, comprising:
a container supported on a frame, the container including a base and sides extending from the base to define an opening opposite the base; and
a curved gas permeable support positioned within the container and cooperating with the base to define a chamber, wherein the gas permeability of the gas permeable support varies along the gas permeable support as a function of the distance between the gas permeable support and the opening.

19. The person-support apparatus of claim 18, wherein the gas permeability of the second portion decreases as the distance between the opening and the second portion decreases.

20. The person-support apparatus of claim 18, wherein the gas permeable support is shaped to mimic a profile of an occupant's body.
